(19) United States
(12) Patent Application Publication
(10) Pub. No.: US 2023/0245205 A1
(43) Pub. Date: Aug. 3, 2023

(54) SYSTEMS AND METHODS FOR GENERATING ORDERED PERSONALIZED ITEM RECOMMENDATIONS BASED ON DATABASE ENTRY CATEGORIES

(71) Applicant: Walmart Apollo, LLC, Bentonville, AR (US)

(72) Inventors: Sriram Guna Sekhar KOLLIPARA, Sunnyvale, CA (US); Kannan Achan, Saratoga, CA (US); Kaushiki Nag, Sunnyvale, CA (US); Evren Korpeoglu, San Jose, CA (US)

(21) Appl. No.: 17/589,541

(22) Filed: Jan. 31, 2022

(51) Int. Cl. G06Q 30/06

(52) U.S. Cl. CPC G06Q 30/0631; G06Q 30/0643

(57) ABSTRACT

A personalized recommendation system can include a computing device configured to receive an indication of a selection from a user device identifying an item, a user, and a third-party. The computing device is configured to obtain historical data for the user and third-party data for the third-party, generate a user representation based on the historical data, and identify a set of items associated with the third-party based on the item. The computing device is configured to obtain attributes for each item and, for each item of the set of items, determine a corresponding ranking based on the third-party data, the user representation, and attributes for the corresponding item. The computing device is configured to organize a display of the set of items based on the corresponding ranking of each item and transmit the organized display of the set of items to the user device for display on a user interface.

### TECHNICAL FIELD

The disclosure relates generally to systems and methods for generating ordered personalized recommendation and more particularly to determining a present personalized recommendation ranking based on database entries.

### BACKGROUND

Customers shop for a variety of different items from a variety of different sellers on ecommerce platforms. For example, customers can visit an ecommerce website on their computing devices or access items for sale through the ecommerce platform using an application on their mobile device. The entity that is associated with the ecommerce platform may sell items and also allow third-party sellers to offer items for sale using the ecommerce platform. Users or customers may purchase items for sale from the entity or directly from third-party sellers via the ecommerce platform.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a personalized recommendation system and related methods. The personalized recommendation system can include a computing device that is configured to receive an indication of a selection from a user device. The selection identifies an item, a user of the user device, and a third-party. The computing device is further configured to obtain historical data for the user and third-party data for the third-party, generate a user representation based on the historical data, and identify a set of items associated with the third-party based on the item. The computing device is also configured to obtain attributes for each item of the set of items and, for each item of the set of items, determine a corresponding ranking based on the third-party data, the user representation, and attributes for the corresponding item. The computing device is configured to organize a display of the set of items based on the corresponding ranking of each item and transmit the organized display of the set of items to the user device for display on a user interface.

In another aspect, the selection includes a selection of an item icon to view a corresponding item, a selection to add a corresponding item to a cart, or a selection submitting a search query.

In another aspect, the user representation is generated by implemented a multi-hot vector representation based on the historical data.

In another aspect, the user representation includes a representation for each product category of items identified in the historical data over a threshold period.

In another aspect, the historical data includes: a product category, each item viewed by the user, each search submitted by the user, each purchase completed by the user, and each item added to a cart by the user.

In another aspect, the corresponding ranking of each item of the set of items is determined by implementing a machine learning algorithm using the third-party data, the user representation, and attributes for the corresponding item.

In another aspect, the computing device is configured to identify the set of items by computing a corresponding semantic embedding between the item and each item of the set of items indicating a relevance value.

In another aspect, each item included in the set of items includes a corresponding semantic embedding above a threshold value.

In another aspect, the third-party data indicates whether the third-party is trusted, a rating of the third-party, a delivery speed associated with the third-party, a return rate associated with the third-party, and a return policy associated with the third-party.

In another aspect, the set of items is reduced to remain below a threshold number of items.

In various embodiments of the present disclosure, a method of providing personalized recommendations is provided. In some embodiments, the method can include receiving an indication of a selection from a user device. The selection identifies an item, a user of the user device, and a third-party. The method includes obtaining historical data for the user and third-party data for the third-party, generating a user representation based on the historical data, and identifying a set of items associated with the third-party based on the item. The method also include obtaining attributes for each item of the set of items and, for each item of the set of items, determining a corresponding ranking based on the third-party data, the user representation, and attributes for the corresponding item. The method further includes organizing a display of the set of items based on the corresponding ranking of each item and transmitting the organized display of the set of items to the user device for display on a user interface.

In various embodiments of the present disclosure, a non-transitory computer readable medium is provided. The non-transitory computer readable medium can have instructions stored thereon, wherein the instructions, when executed by at least one processor, cause a device to perform operations that include receiving an indication of a selection from a user device. The selection identifies an item, a user of the user device, and a third-party. The operations include obtaining historical data for the user and third-party data for the third-party, generating a user representation based on the historical data, and identifying a set of items associated with the third-party based on the item. The operations also include obtaining attributes for each item of the set of items and, for each item of the set of items, determining a corresponding ranking based on the third-party data, the user representation, and attributes for the corresponding item. The operations further include organizing a display of the set of items based on the corresponding ranking of each item and transmitting the organized display of the set of items to the user device for display on a user interface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of a personalized recommendation system in accordance with some embodiments;

FIG. 2 is a block diagram of a computing device implementing the personalized recommendation device of FIG. 1 in accordance with some embodiments;

FIG. 3 is an example user interface presenting personalized recommendations for a particular seller in accordance with some embodiments;

FIG. 4 is a block diagram illustrating an example personalized recommendation module of the personalized recommendation system of FIG. 1 in accordance with some embodiments; and

FIG. 5 is a flowchart of examples methods of identifying and ranking personalized recommendations in accordance with some embodiments.

In the drawings, reference numbers may be reused to identify similar and/or identical elements.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

A personalized recommendation system may be implemented to identify a rank a set of items for a particular seller based on a user or customer's interaction history and the particular seller's statistics on an ecommerce platform. In this way, the personalized recommendation system provides users with recommended items based on what particular sellers are selling, that particular seller's characteristics and performance, and the characteristics that may matter most to the particular user based on the user's historical interactions with the ecommerce platform, such as purchases, add-to-cart selections, views, etc. The personalized recommendation system also provides of method of improving discoverability of items from trusted sellers on the ecommerce platform and improving user confidence of the seller by displaying more of the seller's available items to the user.

In various implementations, the personalized recommendation system may provide interaction feedback to the seller, improving the seller's engagement with the ecommerce platform. For example, the personalized recommendation system may provide the seller with a number of item views, add-to cart selections, and purchases of users that were presented with personalized recommendations from the seller's set of items for sale. Further, the personalized recommendations provided or displayed to the user may be personalized based on the user's historical ecommerce platform interaction, providing more relevant recommendations. Additionally, since the ecommerce platform may prefer a particular entity's items for sale, such as an entity associated with the ecommerce platform, the personalized recommendation system provides a method through which users can specifically browse relevant items from particular sellers, providing potential solutions for particular sellers, such as cold start problems for the seller and corresponding items.

The personalized recommendation system also considers the method through which the user navigated to the seller's page or the seller's items for sale. For example, the user may have input a search query on the seller's page or the ecommerce platform, selected an item for sale by the seller, or added an item of the seller's to the user's cart. From the various data indicating user and seller context, the personalized recommendation system identifies items of the particular sellers to recommend to the user and ranks those items based on the context.

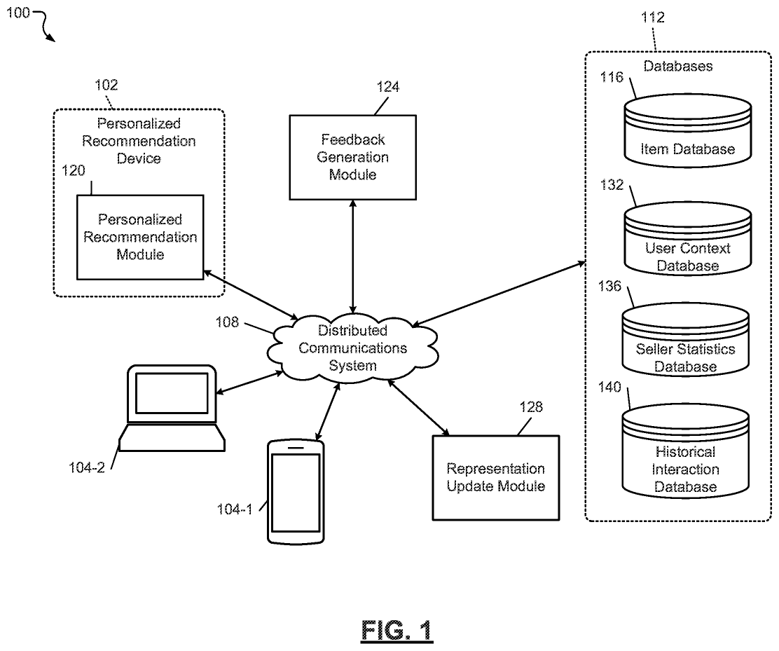

Referring to FIG. 1, a block diagram of a personalized recommendation system 100 is shown. The personalized recommendation system 100 may include a personalized recommendation device 102 and user devices 104-1 and 104-2, collectively user device 104, such as a phone, tablet, laptop, mobile computing device, desktop, etc., capable of communicating with a plurality of databases 112 and modules via a distributed communications system 108. The user device 104 may display an ecommerce marketplace via a web browser or an application for customers to view items for sale by the ecommerce marketplace that are stored in an item database 116. For example, a customer may browse a webpage being display on a graphical user interface of the user device 104 and/or submit a query through the graphical user interface of the user device 104 on the ecommerce marketplace through a web browser or application, which retrieves a subset of items from the item database 116 that pertain to the query and displays the subset of items to the customer via the graphical user interface of the user device 104.

The personalized recommendation system 100 also includes a personalized recommendation module 120, a feedback generation module 124, and a representation update module 128. The personalized recommendation module 120 obtains item identifiers from the item database based on which seller's page or item the user is viewing, selecting, purchasing, etc. The personalized recommendation module 120 also obtains data from a user context database 132, which stores historical data categorized by user, indicating search history, purchase history, view history, add-to-cart history, etc. for each user. Based on data stored in the user context database 132, the personalized recommendation module 120 can generate a user feature vector characterizing the user that is browsing the seller's page.

For example, the user may be using the user device 104 to navigate an application or webpage to view the seller's items for sale. The personalized recommendation module 120 will receive real-time signals associated with each user selection on the user device 104, which indicates with which seller's items the user is interacting, a user identifier, a present session history (characterizing the present shopping session), etc. These real-time signals may be parsed to identify the method through which the user is interacting with the seller's items, the seller, and the user. From these identifying features, the personalized recommendation module 120 obtains seller statistics from a seller statistics database 136 based on the identified seller. The personalized recommendation module 120 may use the data collected from the item database 116, the user context database 132, and the seller statistics database 136 as input to a machine learning algorithm, such as a multilayer perceptron, to rank eligible recommended items according to relevance to the user.

For example, based on seller statistics, the user may be recommended those seller items that are within a particular category that the user has recently viewed. Once the personalized recommendation module 120 identifies eligible items and ranks those items according to the ranking determined by the machine learning algorithm, the personalized recommendation module 120 transmits the item list for display, in the ranked order, to the user device 104 performing the interactions navigating the ecommerce platform causing generation of the real-time signals. That is, when the user is interacting with the ecommerce platform and viewing particular items, searching particular items, etc., a banner of particular items or search results of the recommended items, in the ranked order, are displayed to the user on the user device 104. Item interactions by users categorized by seller may be stored in a historical interaction database 140 that indicates subsequent user interaction, for example, after a user has initiated an interaction for a particular seller. The historical interaction database 140 may also store interactions such as when a user rates a particular seller. In various implementations, the historical interaction database 140 stores each interaction a user has with the ecommerce platform. Additionally, if the user is not logged into a particular user account identifying an associated user identifier, the personalized recommendation system 100 may track guest interactions by a guest identifier. Upon log in, the personalized recommendation system 100 may update the guest identifier to correspond to the user identifier of the log in information.

The feedback generation module 124 may obtain historical user interactions with the ecommerce platform from the historical interaction database 140 according to sellers and, at predetermined intervals, provide the seller with feedback, such as which items were viewed and subsequently purchased, whether particular items were viewed and subsequent items were viewed after viewing a particular item, etc. The feedback generation module 124 may generate feedback reports, for example, weekly, monthly, etc., for sellers and transmit them to an inbox on the ecommerce platform for the sellers to view, email the feedback to an email associated with the sellers' account, etc.

The representation update module 128 may update seller statistics stored in the seller statistics database 136 as well as user historical data stored in the user context database 132 with data stored in the historical interaction database 140 for future use by the personalized recommendation system 100. In various implementations, the user context database 132, the seller statistics database 136, and the historical interaction database 140 may be a single database.

The personalized recommendation device 102 and the user device 104 can be any suitable computing device that includes any hardware or hardware and software combination for processing and handling information. For example, the term “device” and/or “module” can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, the distributed communications system 108. In various implementations, the devices, modules, and databases may communicate directly on an internal network.

As indicated above, the personalized recommendation device 102 and/or the user device 104 can be a computer, a workstation, a laptop, a server such as a cloud-based server, or any other suitable device. In some examples, personalized recommendation device 102 and/or the user device 104 can be a cellular phone, a smart phone, a tablet, a personal assistant device, a voice assistant device, a digital assistant, a laptop, a computer, or any other suitable device. In various implementations, the personalized recommendation device 102 is on a central computing system that is operated and/or controlled by a retailer. Additionally or alternatively, the modules and databases of the personalized recommendation device 102 are distributed among one or more workstations or servers that are coupled together over the distributed communications system 108.

The databases described can be remote storage devices, such as a cloud-based server, a memory device on another application server, a networked computer, or any other suitable remote storage. Further, in some examples, the databases can be a local storage device, such as a hard drive, a non-volatile memory, or a USB stick.

The distributed communications system 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The distributed communications system 108 can provide access to, for example, the Internet.

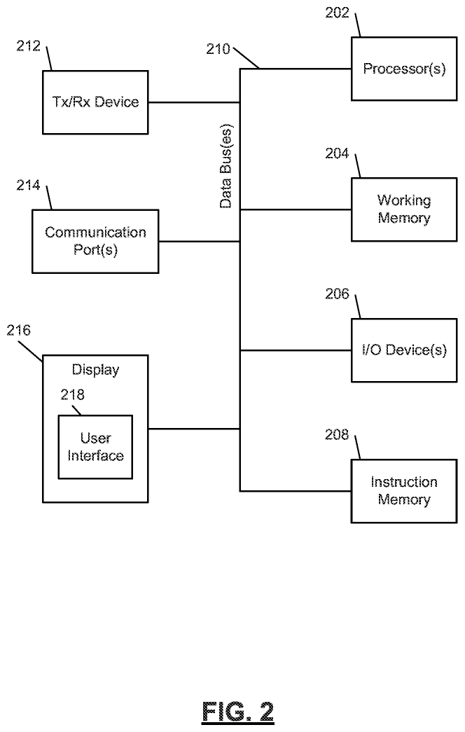

FIG. 2 illustrates an example computing device 200. The personalized recommendation device 102 and/or the user device 104 may include the features shown in FIG. 2. For the sake of brevity, FIG. 2 is described relative to the personalized recommendation device 102.

As shown, the personalized recommendation device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the personalized recommendation device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as data items including feedback information.

Display 216 can display a user interface 218. User interfaces 218 can enable user interaction with the personalized recommendation device 102. For example, user interface 218 can be a user interface that allows an operator to select and browse items via the ecommerce website or marketplace. The user interface 218 can, for example, display the items for sale for a user or customer to view as a result of searching or browsing on an ecommerce marketplace. In some examples, display 216 can be a touchscreen, where user interface 218 is displayed on the touchscreen.

Transceiver 212 allows for communication with a network, such as the distributed communications system 108 of FIG. 1. For example, if the distributed communications system 108 of FIG. 1 is a cellular network, transceiver 212 is configured to allow communications with the cellular network. In some examples, transceiver 212 is selected based on the type of distributed communications system 108 in which the personalized recommendation device 102 will be operating. Processor(s) 202 is operable to receive data from, or send data to, a network, such as the distributed communications system 108 of FIG. 1, via transceiver 212.

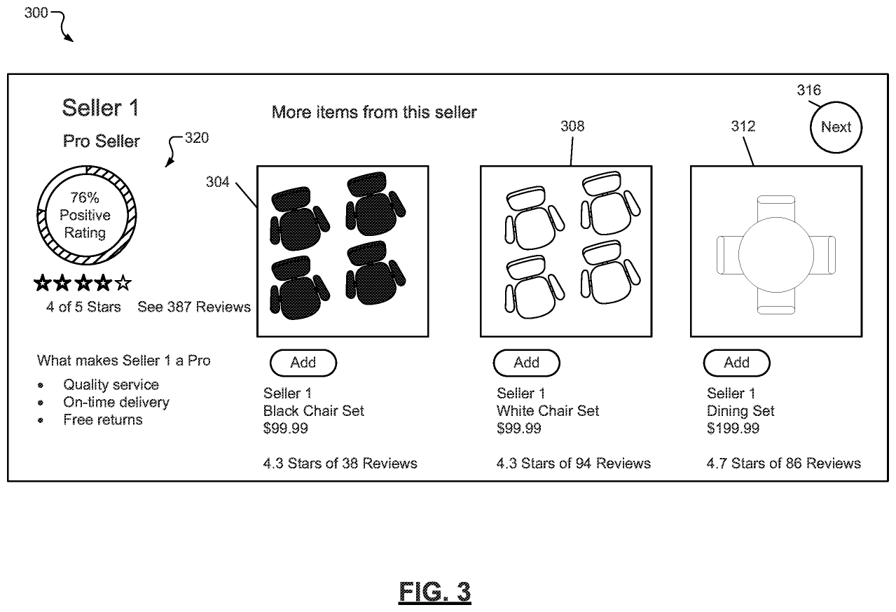

Referring to FIG. 3, an example user interface 300 presenting personalized recommendations for a particular seller is shown. For example, if the user selected to view a particular item of the seller's, searching for a particular item within the seller's items, adding a seller's item to their cart, etc., the user interface 300 including a banner of additional items may be shown below the selected item, after the item is added to the cart or below the search results returned. The banner shows that a first item 304, a second item 308, and a third item 312 are sold by “seller 1,” which may be the seller of the item the user is presently viewing, selected to purchase, or the seller within which the user is searching. Each item has a corresponding add button that the user may select to add to their cart. The banner also includes a next button 316 that the user may select to view more items from the seller. The banner may include an about the seller area 320 indicating the seller is a pro seller, a positive rating amount, a number of stars the seller is rated, a link to a number of seller reviews, and information qualifying the seller to be a pro seller.

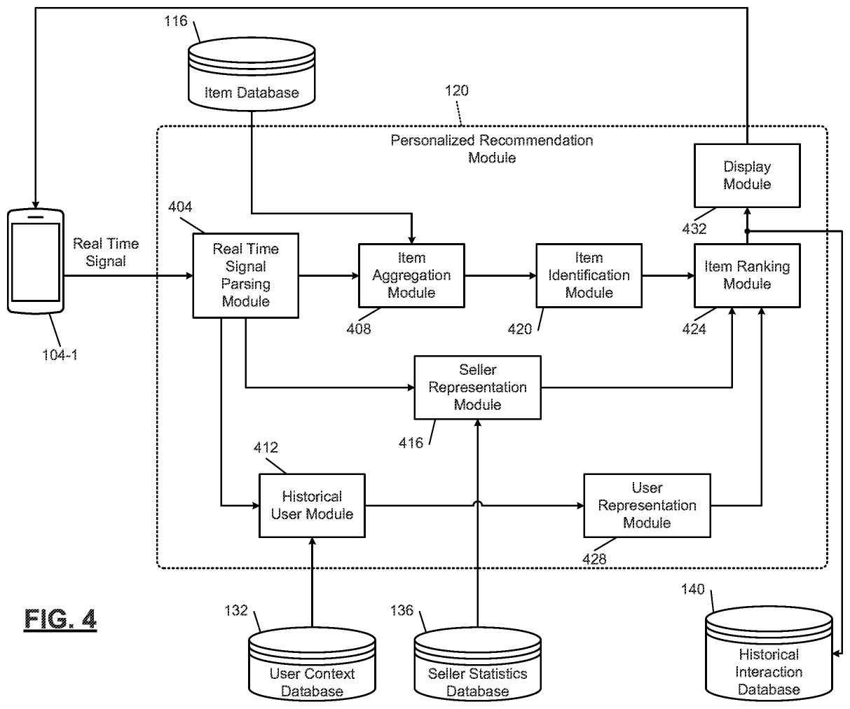

Referring to FIG. 4, a block diagram illustrating an example personalized recommendation module 120 of the personalized recommendation system 100 is shown. The personalized recommendation module 120 includes a real time signal parsing module 404 that receives real time signals from the user device 104-1. As described previously, the real time signals are data indicating or characterizing the occurrence of an interaction by a user with an ecommerce platform, such as a selection of an item. The real time signals may identify the user, identify a seller corresponding with items with which the user is interacting, the item with which the user is interacting, and an interaction type, for example, a view interaction, an add to cart interaction, a search interaction, etc. The real time signal parsing module 404 parses the signal to identify the corresponding item, the interaction type, the corresponding user, and the corresponding seller. The identified item/seller and interaction type is forwarded to an item aggregation module 408, the identified user is forwarded to a historical user module 412, and the identified seller is forwarded to a seller representation module 416.

The item aggregation module 408 obtains items offered for sale by the seller based on the item from the item database 116 along with the characteristics of each item offered for sale by the seller. In various implementations, the item database 116 stores the seller of each item that is offered for sale along with item characteristics, such as product category, price, etc. The aggregated items are forwarded to an item identification module 420 that determines a set of recommended items to return of the aggregated items based on the number of items in the user's cart (which equals one if the interaction type is item view or search), a number of aggregated or candidate items selected by the item aggregation module 408, and a size of the candidate items. For example, the set of items may be identified as a particular maximum number of items or a threshold number of items that may be included in the set of items. In various implementations, from the aggregated items, the item identification module 420 identifies the set of items by implementing a semantic embedding technique based on the item indicated in the real time signal, for example, implementing natural language processing to identify the set of items relevant to the item indicated in the real time signals.

The item identification module 420 may further identify a maximum number of items to include in the set of items based on the candidate items, a number of items in the user's cart (equal to one if the interaction type is item view or search), and a size of the items. The maximum number of items may be determined as a maximum of a dot product of the size of the candidate items and the number of items in the cart (or as noted above, one based on the interaction indication). The dot product may represent the maximum number of the set of items with a highest relevancy according to the semantic embedding determination. In various implementations, there may be a threshold relevancy value between the candidate items and the item indicated in the real time signal. Once the item identification module 420 identifies the set of items, the set of items and the corresponding characteristics are forwarded to an item ranking module 424.

The seller representation module 416 retrieves a set of seller statistics, including, for example, whether the seller is a trusted seller, average seller ratings, delivery speed, quality, seller return rate, whether the seller offers free returns, etc., from the seller statistics database 136. The retrieved seller statistics are forwarded to the item ranking module 424. The historical user module 412 obtains a set of historical interactions for the indicated user from the user context database 132 over a threshold period, for example, the last three days. The collected user data is forwarded to a user representation module 428. The user representation module 428 generations a multi-hot vector representation by implementing machine learning algorithms using the user data according to product category included in the user data. For example, each item may belong to a particular product category, such as a spatula belonging to the product category kitchen utensils. The user data may include purchases, add-to-cart selections, views, searches, etc. for the user.

The vector representations by product category are forwarded to the item ranking module 424. The item ranking module 424 implements a machine learning algorithm, such as a multilayer perception, based on the input of the vector representations of the user, the set of items and their corresponding characteristics (such as, product category, reviews, ratings, price, brand, etc.), and the seller statistics to determine a ranking for each item of the set of items. The item ranking module 424 may indicate a ranking or order of each item of the set of items. The ranking is forwarded to a display module 432 for transmission and display on the user device 104-1. The determine rankings are also forwarded to the historical interaction database 140 for storage.

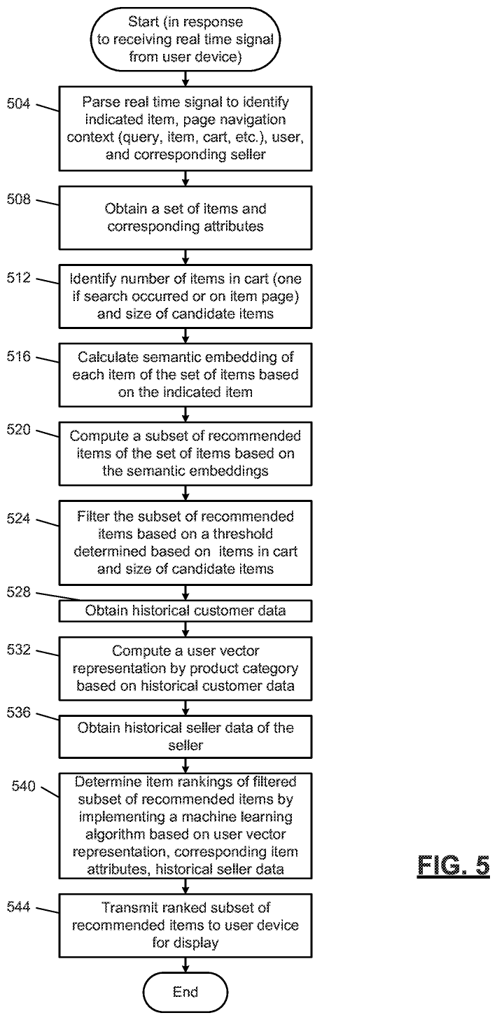

Referring now to FIG. 5, a flowchart of examples methods of identifying and ranking personalized recommendations is shown. Control begins in response to receiving real time signal from user device, as described with respect to FIG. 4. Control continues to 504 to parse real time signal to identify an indicated item, a page navigation context, a user, and a corresponding seller. Control proceeds to 508 to obtain a set of items and corresponding item attributes or characteristics. Control proceeds to 512 to identify a number of items in the cart (which is equal to one if the page navigation context indicates the real time signal is the result of a search query or an item view) and a size of candidate items of the set of items. Control continues to 516 to calculate semantic embeddings of each item of the set of items based on the indicated item. control may implement natural language processing or another machine learning algorithm to generate a numeric indicator indicating semantic similarity between the indicated item and the items of the set of items.

Control proceeds to 520 to compute a subset of recommended items of the set of items based on the semantic embeddings. For example, control may implement a numeric threshold of similarity between the items that are being identified to display to user. Control continues to 524 to filter the subset of recommended items based on a threshold number of items to display determined based on the number of items in cart and the size of the candidate items (described in FIG. 4 as determined by a dot product). Control proceeds to 528 to obtain historical customer data, such as purchase, search, view, add-to-cart history. At 532, control computes a user vector representation by product category based on the historical customer data, for example, implementing a machine learning algorithm. Control proceeds to 536 to obtain historical seller data of the seller, such as seller statistics, described above. Control continues to 540 to determine item rankings of the filtered subset of recommended items by implementing a machine learning algorithm based on the user vector representation, the corresponding item attributes, and historical seller data. Control continues to 544 to transmit the ranked subset of recommended items to the user device for display to the user, for example, in a banner shown in FIG. 3. Then, control ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive an indication of a selection from a user device, the selection identifying an item, a user of the user device, and a third-party;
obtain historical data for the user and third-party data for the third-party;
generate a user representation based on the historical data;
identify a set of items associated with the third-party based on the item;
obtain attributes for each item of the set of items;
for each item of the set of items, determine a corresponding ranking based on the third-party data, the user representation, and attributes for the corresponding item;
organize a display of the set of items based on the corresponding ranking of each item; and
transmit the organized display of the set of items to the user device for display on a user interface.

2. The system of claim 1, wherein the selection includes a selection of an item icon to view a corresponding item, a selection to add a corresponding item to a cart, or a selection submitting a search query.

3. The system of claim 1, wherein the user representation is generated by implemented a multi-hot vector representation based on the historical data.

4. The system of claim 3, wherein the user representation includes a representation for each product category of items identified in the historical data over a threshold period.

5. The system of claim 1, wherein the historical data includes: a product category, each item viewed by the user, each search submitted by the user, each purchase completed by the user, and each item added to a cart by the user.

6. The system of claim 1, wherein the corresponding ranking of each item of the set of items is determined by implementing a machine learning algorithm using the third-party data, the user representation, and attributes for the corresponding item.

7. The system of claim 1, wherein the computing device is configured to identify the set of items by computing a corresponding semantic embedding between the item and each item of the set of items indicating a relevance value.

8. The system of claim 7, wherein each item included in the set of items includes a corresponding semantic embedding above a threshold value.

9. The system of claim 1, wherein the third-party data indicates whether the third-party is trusted, a rating of the third-party, a delivery speed associated with the third-party, a return rate associated with the third-party, and a return policy associated with the third-party.

10. The system of claim 1, wherein the set of items is reduced to remain below a threshold number of items.

11. A method comprising:
receiving an indication of a selection from a user device, the selection identifying an item, a user of the user device, and a third-party;
obtaining historical data for the user and third-party data for the third-party;
generating a user representation based on the historical data;
identifying a set of items associated with the third-party based on the item;
obtaining attributes for each item of the set of items;
for each item of the set of items, determining a corresponding ranking based on the third-party data, the user representation, and attributes for the corresponding item;
organizing a display of the set of items based on the corresponding ranking of each item; and
transmitting the organized display of the set of items to the user device for display on a user interface.

12. The method of claim 11, wherein the selection includes a selection of an item icon to view a corresponding item, a selection to add a corresponding item to a cart, or a selection submitting a search query.

13. The method of claim 11, wherein the user representation is generated by implemented a multi-hot vector representation based on the historical data.

14. The method of claim 13, wherein the user representation includes a representation for each product category of items identified in the historical data over a threshold period.

15. The method of claim 11, wherein the historical data includes: a product category, each item viewed by the user, each search submitted by the user, each purchase completed by the user, and each item added to a cart by the user.

16. The method of claim 11, wherein the corresponding ranking of each item of the set of items is determined by implementing a machine learning algorithm using the third-party data, the user representation, and attributes for the corresponding item.

17. The method of claim 11, further comprising identifying the set of items by computing a corresponding semantic embedding between the item and each item of the set of items indicating a relevance value.

18. The method of claim 17, wherein each item included in the set of items includes a corresponding semantic embedding above a threshold value.

19. The method of claim 11, wherein the third-party data indicates whether the third-party is trusted, a rating of the third-party, a delivery speed associated with the third-party, a return rate associated with the third-party, and a return policy associated with the third-party.

20. A non-transitory computer readable medium having instructions stored thereon, wherein the instructions, when executed by at least one processor, cause a device to perform operations comprising:
receiving an indication of a selection from a user device, the selection identifying an item, a user of the user device, and a third-party;
obtaining historical data for the user and third-party data for the third-party;
generating a user representation based on the historical data;
identifying a set of items associated with the third-party based on the item;
obtaining attributes for each item of the set of items;
for each item of the set of items, determining a corresponding ranking based on the third-party data, the user representation, and attributes for the corresponding item;
organizing a display of the set of items based on the corresponding ranking of each item; and
transmitting the organized display of the set of items to the user device for display on a user interface.
